(19) United States
(12) Patent Application Publication
(10) Pub. No.: US 2006/0251250 A1
(43) Pub. Date: Nov. 9, 2006

(54) METHOD OF GENERATING SUCCESSIONS OF PSEUDO-RANDOM BITS OR NUMBERS

(75) Inventors: Davide Ruggiero, Napoli (IT); Danilo Mascolo, Ercolano (IT); Immacolata Pedaci, Quarto (IT); Paolo Amato, Limbiate (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.I, Agrate Brianza (MI) (IT)

(21) Appl. No.: 11/381,474

(22) Filed: May 3, 2006

(30) Foreign Application Priority Data
May 3, 2005 (IT) VA2005A000027

(51) Int. Cl. H04L 9/00

(52) U.S. Cl. 380/46

(57) ABSTRACT

A method for generating a succession of pseudo-random numbers includes choosing at least one chaotic map, and choosing a seed for the chaotic map and a number of iterations for the chaotic map. The succession of pseudo-random numbers are generated by executing iteratively generating a pseudo-random number as a function of a final state reached by the chaotic map iterated for the current number of iterations starting from the current seed, and generating a new seed for the chaotic map or a new number of iterations as a function of the final state.

### FIELD OF THE INVENTION

The invention relates in general to random number generators, and more particularly, to a very fast method for generating successions of pseudo-random bits or numbers characterized by an extreme sensitivity to initial conditions.

### BACKGROUND OF THE INVENTION

Pseudo-random number generators are fundamental in different applications, such as in scientific research, simulations of stochastic processes, videogames, secure communication protocols, etc. They are particularly important in cryptography. A secure cryptographic system needs a random number generator. Indeed, any ciphering system uses a secret code unknown to hackers. For example, pseudo-random number generators (PRNG) are used for implementing public keys as well as private or secret keys. Cryptography has numerous applications in informatics or in electronics, such as in smart cards, for example.

Smart cards available on the market are excellent for storing data in a secure and convenient way. They may be developed for various applications, such as for encoding (and decoding) data and inserting a digital signature, for example.

The increasing interest for secure applications over the Internet and an intranet, especially in the field of electronic commerce, increases the demand for secure applications using smart cards.

In digital signature processes, the function of a smart card is to generate and to store a private or secret key and insert a digital sign in electronic files. Especially in these applications, it is very important to have an algorithm for generating successions of pseudo-random numbers that cannot be predicted by a hacker

There are numerous manufacturers of smart cards. Most of the smart cards implement the RSA algorithm for generating pseudo-random numbers (e.g., the smart cards of RSA Security, Inc.). The RSA algorithm uses modular operations carried out on integer numbers represented with a large number of bits that are very onerous to be managed, and often require dedicated hardware.

The operations for authenticating a smart card permit the reciprocal acknowledging between the smart card and external the smart card, typically represented by the terminal that interacts with it. According to the ISO standard about security, there are essentially three kinds of authentication: internal authentication, external authentication and reciprocal authentication, that differ among each other depending on the subject that verifies the identity (the external world, the smart card, both). Authentication is mainly carried out between two subjects that are communicating to each other, by exchanging random strings, in certain cases strings that have a temporarily validity (dynamical authentication), that are encrypted in a symmetrical way with the same keys and the same algorithms.

Authentication procedures are usually managed according to the standard ISO 9798/2. External authentication of a smart card allows a system to validate the card with which is interfaced (Internal Authenticate). The operating system generates a Response toward the external world as a function of the received random string (Challenge) and of the encryption key to be used. The external application compares the received Response with what has been obtained by the execution of the authentication algorithm that uses the same Challenge and its own verification key.

FIGS. 1 illustrates an External Authenticate operation that permits a smart card to validate the terminal with which it is interfaced. Usually, the DES (Data Encryption Standard) is used for encrypting the random string (but there are also smart cards that use other algorithms) with an authentication key generated from time to time.

Another device that may implement an authentication system equivalent to the above described one, is formed by a Base Station and a Transponder RFID, that are largely used for realizing keyless entry systems in automotive applications.

Therefore, a PRNG has in these authentication schemes a double role: 1) generating a so-called nonce, that is, a pseudo-random number used only once; and 2) generating the keys of the encryption algorithms chosen for completing the authentication process.

Therefore, it is essential to have a pseudo-random number generator that is at the same time fast and suitable to be implemented in a simple and small circuit. Obviously, it must also be secure, otherwise the generated successions could be relatively easily predicted by exploiting, for instance, their periodicity.

Numerous pseudo-random number generators (PRNG) are available in the literature, such as the Linear Congruential Generators (LCG), the Quadratic Congruential Generators (QCG), the Tausworthe Generators (TG), etc. that have good statistics over relatively long periods. Unfortunately, the successions of generated numbers are not really unpredictable and are vulnerable to certain attacks, thus encryption algorithms that use them are not secure.

The chaotic maps [1] may be used for generating random numbers by exploiting their apparently irregular evolution. The final state reached by a chaotic map after a certain number of iterations is completely determined when the initial state or seed of the map is known, but the extreme sensitivity of the evolution of the chaotic maps to the initial conditions (presuming that the maps have positive Lyapunov exponents) makes even small variations of the initial conditions to cause large variations of the evolution of the system.

This characteristic may be exploited for generating successions of random numbers.

Different cryptographic systems based on chaotic maps [2] and strategies for determining the seed of PRNG in a chaotic fashion [3] are available in literature.

Many PRNG [4] that pass restrictive statistic tests of randomness, generate sequences affected by the “parallel hyperplanes” phenomenon. This problem is typical of LCG and is dangerous in encryption algorithms because these successions have a geometric-type regularity that may be exploited for predicting the numbers that will be generated, and thus for breaking the code.

To better understand the parallel hyperplanes phenomenon a short introduction to the theory of PRNG is presented in the following. B. Schneier [14] defined three different classes of random numbers. The first class is composed by the successions of pseudo-random numbers. That is, those successions that look random and pass all known statistical tests of randomness The LCG are an example of PRNG of this class.

An exhaustive list of these statistical tests has been drafted by Knuth [6]. Moreover, the NIST (National Institute of Standards and Technology) drafted a set of statistical test with the objective of revealing non-random binary successions produced by PRNG to be used in encryption processes.

The second class of random numbers comprises cryptographically secure pseudo-random successions: a PRNG is cryptographically secure if it is very difficult to predict the generated succession. That is, it cannot be reasonably done because of limits of time and complexity of calculations of the present technologies. This is an essential condition for using a PRNG in cryptography.

The third set comprises purely random numbers. The characteristic of the successions of purely random numbers is that they are not reproducible There are different implementations of generators of true random numbers. In general, they are based on certain random physical processes, such as for instance, the thermal noise in a diode.

The following definitions will be used later:

Random number: in cryptography, a random number is the value assumed by a variable, the values of which cannot be predicted by observing the previous values assumed by the variable, even using an infinite calculation capacity;

Unpredictability: a random number generator (RNG) is polynomial-time perfect (or more shortly PT) or simply unpredictable if the time required for predicting the next output of the generator is super-polynomial (e.g., exponential) or the probability of a correct prediction in polynomial time is the same if a random prediction.

The unpredictability may be quantified by calculating certain characteristic parameters of the PRNGs. For example, if a succession of pseudo-random numbers is generated by a PRNG that generates successions the length of which is at most equal to 1, it is possible to list all the successions of length 1 (there are a finite number of them), comparing their output with the observed values, and thus extrapolating the generation algorithm.

The successions of pseudo-random numbers that are unpredictable in polynomial-time are generally based on the intractability of the so-called NP problems, that is, problems of theory of numbers the solution of which requires a time that depends on the variables of the problem according to a non-polynomial law. Among these NP problems, it is worth mentioning the problem of factorization of integer numbers and the so-called discrete logarithm problem, that is, the problem of evaluating the quantity x that satisfies the following relation:
y=g^{x} mod p (1)
wherein p is a prime number.

∞-distributed succession: being U₁, U₂, U₃, . . . a succession of stochastic variables uniformly distributed in the interval [0,1[, a succession is k-distributed if
Probability (u₁≦Uₙ<v₁, . . . uₖ≦Uₙ₊ₖ₋₁<vₖ)=(v₁−u₁) . . . (vₖ−uₖ)
for any choice of the real numbers uⱼ, vⱼ with 0≦uⱼ<vⱼ≦1, for any 1≦j<k. In practice, each vector of k components (Uₙ, . . . , Uₙ₊ₖ₋₁) has the same probability of being verified of any other vector of k components when n tends to infinity.

When k>1, a k-distributed succession is always a (k−11)-distributed succession (it is sufficient to impose uₖ=0 and vₖ=1). A succession is k-distributed (or also super uniform) if it is k-distributed for any positive integer k. This definition has only a theoretical interest and it is not very useful because there are limits of time and computational complexity that may be tolerated.

Statistical tests such as the chi-square test (X² ) allow one to establish, in which measure of a succession of pseudo-random numbers may be considered a k-distributed succession, for any finite k.

This criteria is very important in simulations of stochastic processes because all the numbers in a k-distributed successions are truly independent and have a null self-correlation. It is also possible to demonstrate that such a succession would overcome many, if not all, the present randomness tests.

Pseudo-random bit generator (PRBG): a pseudo-random bit generator (PRBG) is a deterministic algorithm that processes input random binary successions of length k and outputs randomly distributed binary successions of length 1>>k. The input of the PRBG is the seed of the generator, while its output is the pseudo-random bit succession [5].

The output of the PRBGs is not random, indeed the number of possible output successions is a small fraction (more precisely k/1) of all possible binary successions of length 1. The objective of the PRBG is of “expanding” small random successions (the bits of the seed) in a pseudo-random bit succession of larger length such that for a hacker it would be impossible to distinguish a pseudo-random bit succession of length 1 from a truly random succession of equal length.

“Polynomial-time” randomness test: a pseudo-random bit generator passes all the polynomial-type randomness tests if no polynomial-time algorithm may correctly distinguish between an output succession of the generator and a truly random succession of the same length with probability significantly larger than ½.

Next-bit test: a PRBG passes the next-bit test if, given the first 1 bits of an output succession s, there is no polynomial time algorithm capable of predicting the (1+1) th bit of the succession s with a probability significantly larger than ½.

A PRBG that passes the next-bit test and for which it is possible to make reasonable mathematical hypothesis (even if not proven) in favor of the unpredictability of the generated sequences (such as the intractability of the factorization of integer numbers), it is said to be a “cryptographically secure pseudo-random bit generator” or CSPRBG.

A k^{th}-order linear recurrence generator is a generator that outputs a succession {xᵢ}_{1≧0} of pseudo-random numbers defined by recurrence by the following equation:

$${x}_{i + k} = ( {\sum }_{j = 1}^{k} {a}_{k - j} {x}_{i + k - j} + c ) mod m 0 \leq {x}_{i} \leq m \qquad ( 2 )$$

wherein a₀, . . . , aₖ₋₁, c are integer numbers chosen in the set Zₘ=55 0,1,2, . . . m−1} with a₀≠0 and in which m is a positive integer. The number xᵢ₊ₖ may be calculated with the following equations:

$${x}_{i + k} = {\sum }_{j = 1}^{k} {a}_{k - j} {x}_{i + k - j} + c - {r}_{i} m \qquad ( 3 )$$

wherein

$${r}_{i} [ {m}^{- 1} ( {\sum }_{j = 1}^{k} {a}_{k - j} {x}_{i + k - j} + c ) ] \qquad ( 4 )$$

wherein the operator in the brackets [. . . ] extracts the integer part of its argument.

The case for k=1 refers to the class of the linear congruential generators, while the case k=1 and c=0 refers to the pure multiplicative congruential method

The LCG have the following drawbacks:

pertodicity: given an initial seed x₀, there is an n smaller than or at most equal to a certain maximum M such that xₙ=x₀, that is, the generator is periodical with period n;

parallel hyperplanes: representing graphically the set of k-dimensional points (xₙ, xₙ₊₁, . . . x_{n 30 k-1}) for each n in a k-dimensional space all points belong to hyperplanes [7].

There are different types of PRNG that are fast, do not involve an onerous computational load and have good statistical properties and this would make them potentially appropriate for being implemented by not cumbersome circuits embedded in smart cards Unfortunately, the successions of numbers generated by it may be predicted. For this reason they are not considered suitable for cryptographic applications

Some authors studied successfully several ways of predicting successions of pseudo-random numbers obtained with these generators Plumstead [8] and Boyar

showed how to predict the output of a linear congruential generator given only few numbers of the output succession and with unknown parameters a, b and m. Boyar showed that the multivaried linear congruential generators
xₙ=(a₁ xₙ₋₁+a₂ xₙ₋₂+ . . . +a₁·xₙ₋₁+b) mod m (10)
and the quadratic congruential generators
(xₙ=(a·xₙ₋₁²+b·xₙ₋₁+c) mod m (11)
are unfit for cryptography because they are not secure. Krawczyk [10] generalized these results and showed how the output of any multivaried polynomial congruential generator can be effectively predicted

A truncated linear congruential generator is a generator in which a fraction of the least significant bits may be effectively predicted if the parameters of the generator a, b and m are known. Stern [12] extended this method to the case in which only m is known. Boyar disclosed an effective algorithm for predicting linear congruential generators in which a number of bits on the order of the logarithm of the logarithm of m (or more briefly O (log(log m))) are discarded, and in which the parameters a, b and m are unknown.

The generators of truly random numbers appear more suitable for cryptographic applications because the numbers or bits generated by them are due to physical processes It is worth mentioning that randomness, in physical phenomena, is due to stochastic variables that, in general, are not uniformly distributed. In order to prevent that also the generated successions of numbers or bits be biased, that is the generated numbers or bits be not uniformly distributed, it is necessary to have a correction circuit.

This correction circuit carries out calculations that are often onerous, for compensating the effects of the bias of the stochastic variables of the exploited physical phenomenon and it may be designed only if the physical laws of the phenomenon are known. Moreover, environmental conditions (for instance the temperature) may significantly modify the evolution of the physical phenomenon, and thus make inadequate the compensation carried out by the correction circuit.

### SUMMRY OF THE INVENTION

An object of the invention is to provide a method for generating numbers or bits unpredictable at least in a polynomial time, and thus suitable for cryptographic applications, that is at the same time fast, independent from environmental conditions and easily implementable in systems embedded in smart cards.

This and other objects, features and advantages are provided by a method for generating successions of pseudo-random numbers or bits that is straightforward to implement and is fast. Straightforward mathematical considerations induce to sustain that the generated successions are not affected by the parallel hyperplanes phenomenon or by periodicity. The generated pseudo-random successions are extremely sensitive to initial conditions, and thus they are substantially unpredictable, even if deterministic.

Therefore, differently from the prior art pseudo-random number generators (PRNG) currently available, with the method of the invention it is possible to generate successions of pseudo-random numbers or bits with a low computational cost, It is also suitable to be used in cryptographic applications that require PRNG with particularly high performances. Moreover, the method of the invention may be easily implemented in devices embedded in smart cards or for encrypting transmissions in GSM systems.

This advantageous result is obtained by calculating the numbers or bits of the pseudo-random succession to be generated as a function of the final state reached by one or more chaotic maps iterated for a number of times starting from an initial state. According to the invention, the initial state and/or the number of iterations of the chaotic map are updated at the end of each iteration cycle as a function of the state reached by the chaotic map (or maps).

Even if a hacker knew a relatively long sequence of generated bits or numbers, he would not have any information on the initial state of the generator, nor have the possibility of predicting the successive pseudo-random number or bit.

Preferably, the pseudo-random numbers or bits are calculated as a function of the final state reached by the chaotic map by using a nonlinear function the inverse of which has numerous branches.

The above described method may be conveniently implemented using software code executed by a processor.

Another aspect of the invention is directed to an architecture for encrypting GSM communications that implements the above described method.

### BRIEF DESCRIPTION OF THE DRAWINGS

This invention will be described referring to the attached drawings, wherein:

FIG. 1 illustrates schematically a procedure for authenticating a smart card embedded with a chip in accordance with the prior art;

FIG. 2 is a basic diagram that illustrates an embodiment for generating pseudo-random successions of bits in accordance with the present invention;

FIG. 3 is a detailed diagram that illustrates an embodiment for generating pseudo-random successions of bits in accordance with the present invention;

FIG. 4 depicts an embodiment for an architecture for codifying GSM transmissions in accordance with the present invention.

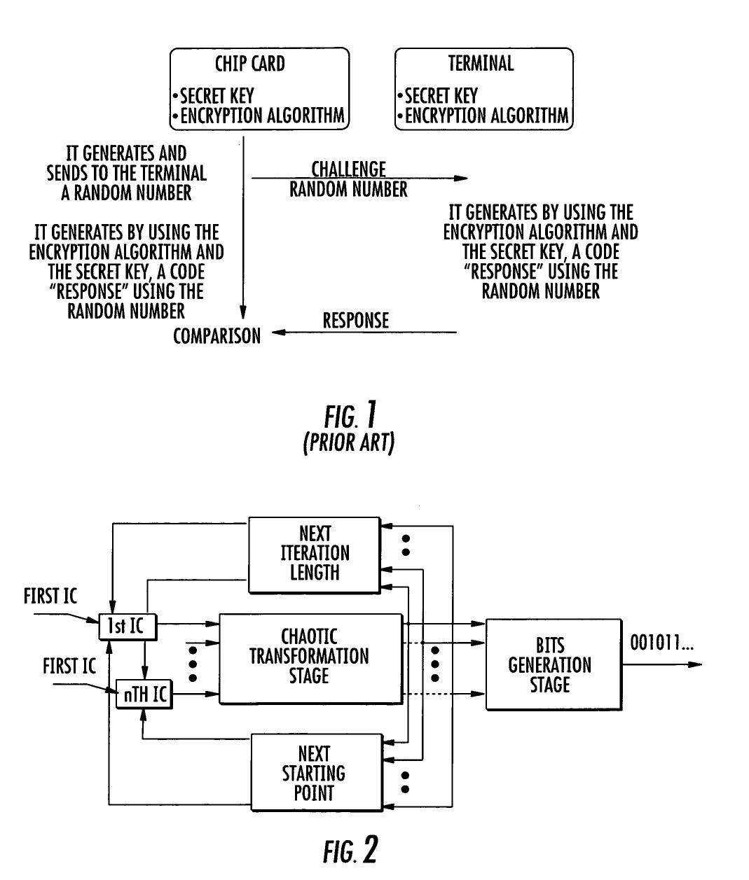

### DETAILED DESCRIPTION OF THE PREFERRED EMBODIMENTS

The method of the invention for generating pseudo-random numbers is substantially based on a chaotic map iterated a certain number of times starting from a seed. The number of iterations and/or the seed is updated for each pseudo-random number to be generated as a function of the final state reached by the map.

A chaotic map f, a seed z₀ and an integer number of iterations k₀ are chosen. The chaotic map f is iterated from the seed z₀ for the number k₀ of times and a pseudo-random number p₀ is generated as a function of the final state reached by the map, preferably by using a nonlinear function the inverse of which has a plurality of branches. Therefore, depending on the state reached by the chaotic map, a new seed z₁ and/or a new number of iterations k₁ are generated, and so on.

Preferably, the number of iterations k of the chaotic map is chosen by using nonlinear functions defined on the phase space of the map and that assume integer values. The choice of the function for determining the new seed is not particularly relevant, and even a linear function may be used.

According to one embodiment of the invention, each number of the pseudo-random succession is obtained as a function of the states reached by a plurality of chaotic maps, even different among them, iterated for a respective number k of times starting from respective seeds z.

The invention will be illustrated referring to a method for generating pseudo-random successions of bits, but the same considerations hold for generating pseudo-random numbers.

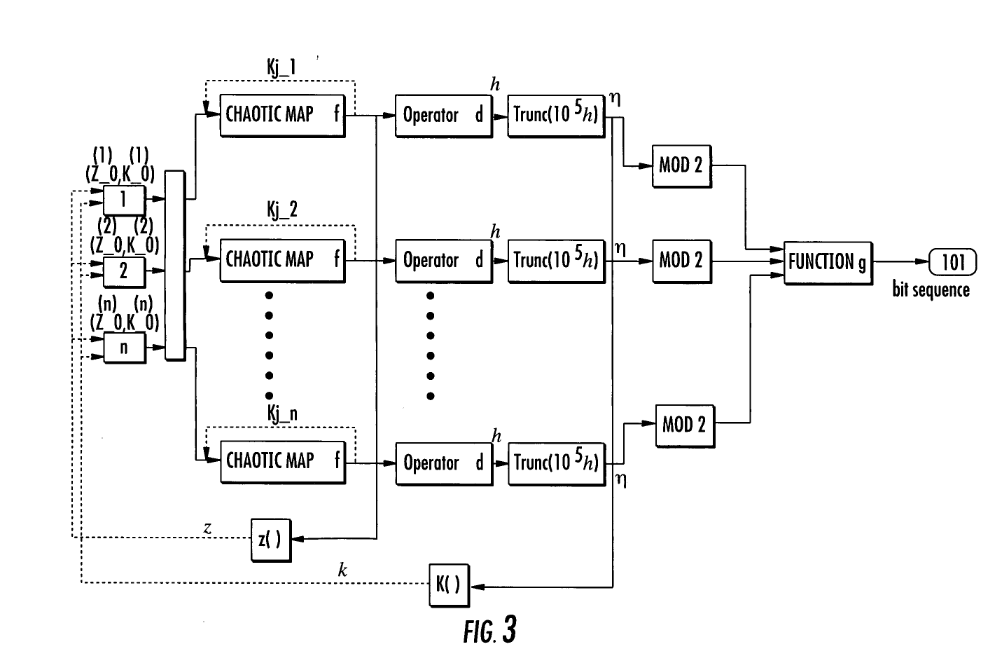

FIG. 2 shows a basic diagram of one embodiment that uses n chaotic maps. For each chaotic map, a user establishes a first pair IC of initial conditions constituted by an initial number of iterations k and by a seed z. The block CHAOTIC TRANSFORMATION STAGE implements the chaotic maps and iterates each of them for the respective number of iterations starting from the respective seed. The blocks NEXT ITERATION LENGTH and NEXT STARTING POINT calculate, as a function of the states reached by the maps at the end of each cycle of iterations, new numbers of iterations and new seeds of the maps, respectively.

In the system of FIG. 2, the number of iterations k and the seed z of a generic m^{th} chaotic map depend in general on the set of final states reached by all the chaotic maps and not only by the final state of the m^{th} map. Therefore, the evolution of each chaotic map depends also on the evolution of the other chaotic maps. This will make even more unpredictable the final states that these maps will reach at the end of each cycle of iterations.

Tests carried out showed that, even when each chaotic map evolves independently from the others, that is, when the seed and the number of iterations is calculated exclusively as a function of the state reached by the map itself, the succession of pseudo-random numbers or bits is practically unpredictable.

In this case, the functions implemented by the blocks NEXT ITERATION LENGTH and NET STARTING POINT are less onerous from a computational point of view. Moreover, the generator of FIG. 2 may be realized according to a modular architecture, wherein each module implements a respective chaotic map and the relative functions for calculating the number of iterations k and the seed z. The final stage BITS GENERATION STAGE generates a bit as a function of all the states reached by the chaotic maps at each cycle of iterations.

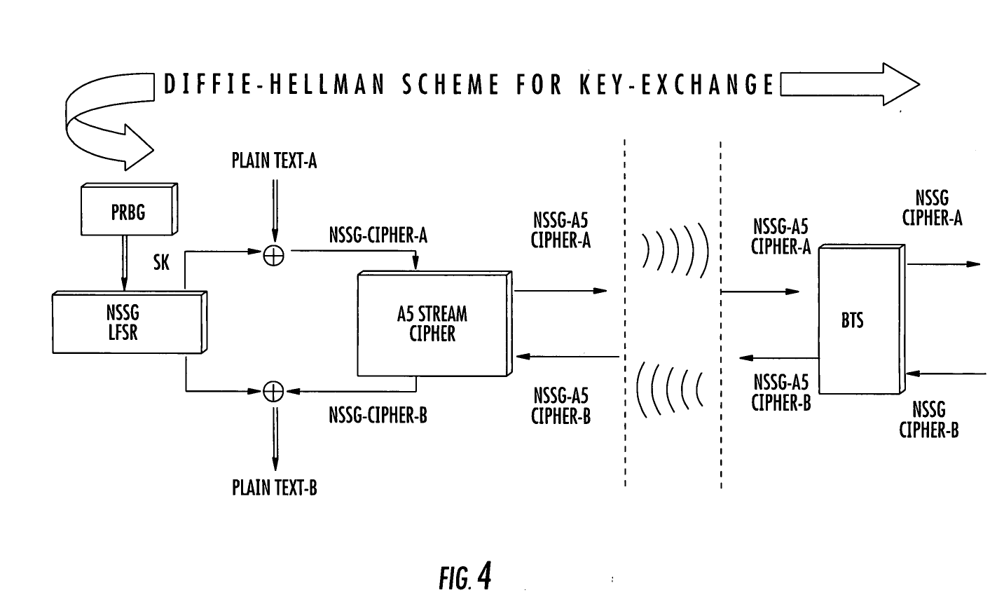

Another embodiment of the bit generator is depicted in FIG. 3, and is based on the use of n chaotic maps defined on the same phase space. The seeds of the maps are conveniently calculated by a same function Z(.). This is possible because the maps are defined on the same phase space. Preferably, the function Z(.) is the identity function.

The number of iterations is calculated by applying a nonlinear function d assuming nonnegative real values on elements x of the phase space of the maps,
h=d(\overline{x})
truncating the decimal part of each real value after having multiplied it by a pre-defined power of ten,
η=Trnc(10²·h)
and applying a same function K(.) on the so-obtained integer numbers:
k=K(η)=K(Truc(10^{s}·d(\overline{x})))

Finally, each integer η is converted in a bit by calculating its remainder modulo 2, thus obtaining an intermediate bit for each chaotic map. The block FUNCTION_G generates a bit of the output pseudo-random succession by applying a function g(.) on the string of the n intermediate bits.

Preferably, the chaotic maps are the Henon

$$H ( x , y ) \text{:} \{ \begin{matrix} {x}_{n + 1} = 1 - α \cdot {x}_{n}^{2} + {y}_{n} \\ {y}_{n + 1} = β \cdot {x}_{n}\end{matrix} \qquad ( 5 )$$

or the Lozi map L(x,y),

$$L ( x , y ) \text{:} \{ \begin{matrix} {x}_{n + 1} = 1 - α \cdot \vert {x}_{n} \vert + {y}_{n} \\ {y}_{n + 1} = β \cdot {x}_{n}\end{matrix} \qquad ( 6 )$$

and the values assumed by the function d are equal to the sum of the absolute values of the components of the state reached by a map:
d(\overline{x})=d(x, y)=|x|+y| (7)

The function d defined by eq. (7) is nonlinear and it is very simple to be implemented. Other nonlinear functions may be chosen for generating a real number as a function of a vector of the phase space, such as for example, the norm function:
d(x,y)=\sqrt{x²+y²} (5)
but this function is onerous to be carried out because it requires the execution of multiplications and the extraction of a square root.

Preferably, the function K(.) is defined by the following equation:
K(ξ)=ξmod p+c (9)
wherein the numbers p and c are pre-established integer numbers.

The function g (.) that combines the intermediate bits of the bit string in a single output random bit may be, for example, a logic XOR operation or any function the inverse of which has a plurality of branches.

If numbers are to be generated instead of pseudo-random bits, it is possible to use a scheme similar to that of FIG. 3. It is sufficient to eliminate the blocks MOD2 that convert the numbers in bits and choosing a function g(.) assuming integer numbers and being defined on strings of numbers. For instance, the function g(.) could be a hash function [5], or any function the inverse of which has a plurality of branches

If pseudo-random hexadecimal (or in any other pre-established base) numbers are to be generated, a function g(.) assuming hexadecimal (or in the pre-established base) values is to be chosen.

Some simple mathematical considerations, even if they do not prove the unpredictability of the generated succession numbers or bits, induce one to consider the successions generated according to the method of the invention to be effectively unpredictable with actually available calculation means. Known as a succession of k numbers or bits b₁, bᵢ₊₁, . . . , bᵢ₊ₖ₋₁, it is not possible to predict with a polynomial time algorithm the number or bit bᵢ₋₁ or bᵢ₊ₖ generated according to the method of the invention.

First of all, tests carried out showed that successions of generated numbers or bits are not affected by the parallel hyperplanes phenomenon nor by periodicity, that limit the performances of the LCG. Moreover, each number or bit of the output pseudo-random succession is a combination of more intermediate numbers or bits, each generated by a respective chaotic map, carried out with a function g(.) the inverse of which has numerous branches. As a consequence, it is impossible to predict the various intermediate numbers or bits by knowing only one output number or bit.

Knowing a succession of numbers or intermediate bits generated with a same map, besides being apparently impossible because of what has been said above, would not be useful at all. Indeed, each intermediate number or bit is obtained by iterating a chaotic map for a variable number of times starting from seeds that change at each cycle of iterations and by applying a function with numerous inverse functions on the state reached at the end of each cycle of iterations.

Moreover, a same sequence of k intermediate numbers or bits may be obtained also in correspondence of different combinations of final states reached by the chaotic maps. Therefore, even knowing such a sequence of length k, the successive pseudo-random number or bit is not univocally determined.

Finally, even if a final state of a map was known with a relatively reduced approximation margin, it would be very difficult to predict the state that will be reached at the end of the successive cycle of iterations. Indeed, uncertainty in determining the final state would cause an uncertainty on the seed of the successive cycle of iterations, and thus an uncertainty in determining the final state reached by the chaotic map that increases with an exponential law in function of the number of executed iterations.

These considerations induce one to consider the pseudo-random successions of numbers or bits of the method of the invention unpredictable with any polynomial time algorithms.

The method of the invention for generating successions of pseudo-random bits depicted in FIG. 3 has been tested with the set of tests FIPS [5] and with the test Die-Hard [13] and the following results have been obtained:

| Test | Result |
|---|---|
| Birthday Spacings | pass |
| Overlapping 5-permutation | pass |
| Binary rank for 31 × 31 | pass |
| matrices | |
| Binary rank for 32 × 32 | pass |
| matrices | |
| Binary rank for 6 × 8 | pass |
| matrices | |
| Bitstream | pass |
| OPSO | pass |
| OQSO | pass |
| DNA | pass |
| Count the 1's on a stream | pass |
| of bytes | |
| Count the 1's for | pass |
| specific bytes | |
| Parking lot | pass |
| Minimum distance | pass |
| 3DSpheres | pass |
| Squeeze | pass |
| Overlapping sums | pass |
| Runs | pass |
| Craps | pass |

The method of the invention allows generation in an extremely fast and straightforward manner successions of numbers or bits that are practically unpredictable. For this reason, differently from known methods, the method of the invention may be conveniently used in secure cryptographic applications and implemented in systems embedded in smart cards.

The invention may be conveniently used also in GSM systems A GSM network is composed essentially of four subsystems:

1) Mobile Station (MS or terminal): a cellular phone;

2) Base Station Subsystem (BSS or “bridge”): a subsystem composed of the BTS (Base Transceiver Station) that establishes a full duplex radio contact with the GSM terminal, and of the BSC (Base Station Controller) that interacts with the cellular network and with the other close BTS;

3) Network Subsystem (NS or switching point): operates as a switching point for a certain zone, and also manages phone calls and authentication procedures;

4) Operation and Support Subsystem (OSS or “central” system): it is the electronic system that manages in a centralized and computerized fashion the whole GSM network of a certain mobile phone operator

Typically, data transmitted between the Mobile Station and the Base Transceiver Station are encrypted, while they are transmitted in plaintext mode through the Operation and Support Subsystem As a consequence, a GSM communication may be very easily intercepted by intercepting the transmissions between the BTS and the OSS.

To prevent a communication between two users A and B from being intercepted, it is possible to use two architectures identical to the encoding architecture for GSM systems depicted in FIG. 4, one from the side of user A and the other from the side of user B.

While in a common GSM protocol the block A5 STREAM CIPHER sends plaintext information PLAINTEXT-A to the BTS, the shown architecture encodes/decodes data to be transmitted/received through a generator of pseudo-random sequences of bits PRBG and a generator of encoding strings (Stream Cipher) NSSG. The generator NSSG comprises preferably a Stream Cipher of the type Self-Shrinked [14J, that generates an intermediate string and a logic circuit that generates the encoding/decoding string as a function of the intermediate string by using a Boolean function

When two users A and B want to communicate between them, the two identical pseudo-random bit generators PRBG, one from the side of user A and the other from the side of user B, are started from a same seed, that is exchanged preferably by using the Diffie-Hellman protocol. The two PREBS thus evolve through the same states and generate at the same time the same pseudo-random bits.

Successively, the following steps are carried out each time a packet of data is sent or received: the PRBG generates a key SK; the block NSSG generates an encoding/decoding string starting from the key SK; the encoded bits NSSG-Cipher-A to be transmitted are generated as logic XOR among the plaintext bits PLAINTEXT-A and the bits of the encoding/decoding string; and the encoded bits NSSG-CIPHER-A are sent to the block A5 STREAM CIPHER, that transmits them to the BTS.

The same process takes place for sending encrypted bits from the user B to the user A. According to an alternative embodiment, the encoding string is the key SK, thus the block NSSG may be omitted.

Preferably, the key SK, previously generated by the PRBG available on both sides, is changed letting the PRBG evolve simultaneously such that both generate a same new key SK. As a consequence, the blocks NSSS from the side of user A and of user B generate the same encryption/decryption strings.

This must happen because, if data were not decrypted at the receiver with the same key used for encrypting them at the transmitter, it would be impossible to decrypt them.

The block A5 STREAM CIPHER is input with data encrypted by the user B, that are converted in the corresponding plaintest message PLAINTEXT-B by XORing the encrypted bits NSSG-CIPHER-B and the decryption string currently generated by the block NSSG, that is, the same used at the transmitter side for encryption.

Preferably, the key SK is changed at each sent or received packet of bits (typically composed of 228 bits). In GSM communications a packet of bits is sent at each 4.3 ms, thus it is essential the PRBG be fast, otherwise the communication could be slowed down.

A microprocessor that executes a software computer program for implementing the method of the invention for generating pseudo-random sequences of bits, is capable of generating the bits of the key SK very fast and in a practically unpredictable way.

### REFERENCES

[1] Gregory L. Baker, “Chaotic dynamics”, Cambridge University Press, 2000.

[2] J. Jimenez P. Garcia, “Communication through chaotic map systems”, Physics Letters A, 298, pages 35-40, 2002.

[3] U.S. Pat. No. 5,732,138, L. Curt Noll, P. Mende and S. Sisodiya, “Method for seeding a pseudo-random number generator with a cryptographic hash of a digitizing of a chaotic system”.

[4] EP 1,420,542, L. Kocarev, P. Amato, and G. Rizzotto, “Method of generating a chaos-based pseudo-random sequence and a hardware generator of chaos-based pseudo random bit sequences”.

[5] P. van Oorschot, A. Menezes and S. Vanstone, “Hadbook of Applied Cryptography”, CRC Press, 1997.

[6] Donald E. Knuth, “The art of computer programming”, Addison-Wesley, 1969.

[7] C. E. Shannon, “Random numbers fall mainly in the planes”, Proc. Nat. Acad. Sci. U.S.A., 62:25-28, 1968.

[8] J. B. Plumstead, “Inferring a sequence generated by a linear congruence”, IEEE 23^{rd} Symposium on Foundations of Computer Science, pages 153-159, 1982.

[9 J. Boyar, “Inferring sequences produces by pseudo-random number generators”, Journal of the Association of Computing Machinery, pages 129-142, 1989.

[10] H. Krawczyk, “How to predict congruential generators”, Journal of Algorithms, pages 527-545, 1992

[11] R. Kannan, J. C. Lagarias, A. M. Frieze, J. Hastad and S. Shamir, “Reconstructing truncated integer variables satisfying linear congruences”, SIAM Journal of Computing, pages 262-280, 1988.

[12] J. Stern, “Secret linear congruential generators are not cryptographically secure”, IEEE 28^{th} Symposium on Foundations of Computer Science, pages 421-426, 1987.

[13] George Marsaglia <http://stat.fsu.edu/geo/diehard.html>.

[14] Bruce Schneier, “Applied Cryptography”, John Wiley and Sons Inc., New York, 1996.

1-14. (canceled)

15. A method for generating a succession of pseudo-random numbers comprising:
choosing at least one chaotic map;
choosing a seed for the chaotic map and a number of iterations for the chaotic map;
generating the succession of pseudo-random numbers executing iteratively the following:
a) generating a pseudo-random number as a function of a final state reached by the chaotic map iterated for the current number of iterations starting from the current seed, and
b) generating a new seed for the chaotic map or a new number of iterations as a function of the final state

16. A method according to claim 15, further comprising choosing a first function defined on a phase space of the chaotic map and having values in it, and a second nonlinear function defined on the phase space of the chaotic map and with values in a set of natural numbers; and wherein generating the new seed or the new number comprises applying respectively the first and second functions on the final state.

17. A method according to claim 15, wherein choosing at least one chaotic map comprises choosing a plurality of chaotic maps and as many seeds and numbers of iterations; and further comprising:
choosing a third function;
generating an intermediate succession of pseudo-random numbers for each chaotic map; and
generating each pseudo-random number of the intermediate succession by combining with the third function the pseudo-random numbers that are currently generated by each of the chaotic maps.

18. A method according to claim 17, wherein the first and second functions are chosen for each chaotic map.

19. A method according to claim 15, wherein the pseudo-random numbers generated by the chaotic map are obtained by multiplying by a pre-established power of ten a sum of an absolute value of the components of the state reached by the chaotic map after the number of literations and keeping only the integer part of the product.

20. A method according to claim 15, wherein in a phase space of the chaotic map there is at least one attractor basin and the seed is chosen from inside the attractor basin.

21. A method for generating a pseudo-random succession of numbers or bits in a pre-established base, the method comprising:
choosing a plurality of chaotic maps and as many seeds and numbers of iterations;
choosing a function;
generating an intermediate succession of pseudo-random numbers for the plurality of chaotic maps;
generating each pseudo-random number of the intermediate succession by combining with the function the pseudo-random numbers that are currently generated by each of the chaotic maps;
generating the succession of pseudo-random numbers executing iteratively the following:
a) generating a pseudo-random number as a function of a final state reached by the plurality of chaotic maps iterated for the current number of iterations starting from a current seed, and
b) generating a new seed for the plurality of chaotic maps or a new number of iterations as a function of the final state.

22. A method according to claim 21, further comprising:
converting each pseudo-random number currently generated by each chaotic map in a respective intermediate bit or intermediate number in the pre-established base;
generating a string of bits or numbers in the pre-established base comprising respectively of the intermediate bit or intermediate numbers in the pre-established base obtained above; and
generating a respective pseudo-random bit or a pseudo-random number in the pre-established base for the succession to be generated respectively as a function of the string of bits or numbers.

23. A computer-readable medium having computer-executable instructions for causing a computer to perform steps comprising:
choosing at least one chaotic map;
choosing a seed for the chaotic map and a number of iterations for the chaotic map;
generating the succession of pseudo-random numbers executing iteratively the following:
a) generating a pseudo-random number as a function of a final state reached by the chaotic map iterated for the current number of iterations starting from the current seed, and
b) generating a new seed for the chaotic map or a new number of iterations as a function of the final state.

24. A computer-readable medium according to claim 23, further comprising choosing a first function defined on a phase space of the chaotic map and having values in it, and a second nonlinear function defined on the phase space of the chaotic map and with values in a set of natural numbers; and wherein generating the new seed or the new number comprises applying respectively the first and second functions on the final state.

25. A computer-readable medium according to claim 23, wherein choosing at least one chaotic map comprises choosing a plurality of chaotic maps and as many seeds and numbers of iterations; and further comprising:
choosing a third function;
generating an intermediate succession of pseudo-random numbers for each chaotic map; and
generating each pseudo-random number of the intermediate succession by combining with the third function the pseudo-random numbers that are currently generated by each of the chaotic maps.

26. A computer-readable medium according to claim 25, wherein the first and second functions are chosen for each chaotic map.

27. A computer-readable medium according to claim 23, wherein the pseudo-random numbers generated by the chaotic map are obtained by multiplying by a pre-established power of ten a sum of an absolute value of the components of the state reached by the chaotic map after the number of iterations, and keeping only the integer part of the product.

28. A computer-readable medium according to claim 23, wherein in a phase space of the chaotic map there is at least one attractor basin and the seed is chosen from inside the attractor basin.

29. A device for generating a succession of pseudo-random numbers or bits comprising:
a processor for executing the following choosing at least one chaotic map, choosing a seed for the chaotic map and a number of iterations for the chaotic map, generating the succession of pseudo-random numbers executing iteratively the following
a) generating a pseudo-random number as a function of a final state reached by the chaotic map iterated for the current number of iterations starting from the current seed, and
b) generating a new seed for the chaotic map or a new number of iterations as a function of the final state.

30. A device according to claim 29, wherein said processor chooses a first function defined on a phase space of the chaotic map and having values in it, and a second nonlinear function defined on the phase space of the chaotic map and with values in a set of natural numbers; and wherein generating the new seed or the new number comprises applying respectively the first and second functions on the final state.

31. A device according to claim 29, wherein choosing at least one chaotic map by said processor comprises choosing a plurality of chaotic maps and as many seeds and numbers of iterations; and wherein said processor further performs the following:
choosing a third function;
generating an intermediate succession of pseudo-random numbers for each chaotic map; and
generating each pseudo-random number of the intermediate succession by combining with the third function the pseudo-random numbers that are currently generated by each of the chaotic maps.

32. A device according to claim 31, wherein the first and second functions are chosen by said processor for each chaotic map.

33. A device according to claim 29, wherein the pseudo-random numbers generated by the chaotic map are obtained by multiplying by a pre-established power of ten a sum of an absolute value of the components of the state reached by the chaotic map after the number of iterations, and keeping only the integer part of the product

34. A device according to claim 29, wherein in a phase space of the chaotic map there is at least one attractor basin and the seed is chosen from inside the attractor basin

35. An architecture for encrypting/decrypting packets of bits to be transmitted or received, the architecture comprising:
a device for generating a communication key comprising pseudo-random bits;
a generator for generating an encryption/decryption string as a function of the communication key;
an encoding XOR gate for generating a succession of encrypted bits to be transmitted as logic XOR among bits of the encryption/decryption string and bits of at least a packet of bits to be transmitted; and
a decoding XOR gate for generating a succession of decoded bits as a logic XOR among the bits of the encryption/decryption string and bits of at least a packet of bits encoded and received.

36. An architecture according to claim 35, wherein said generator comprises:
a stream cipher configured as a self-shrinked type for generating an intermediate string; and
a logic circuit being input with the intermediate string, and generating the encryption/decryption string according to a nonlinear Boolean function.

37. An architecture according to claim 35, wherein the encrypting/decrypting string is identical to communication key.

38. An architecture according to claim 35, wherein said device for generating the communication key comprises a processor for performing the following:
choosing at least one chaotic map, choosing a seed for the chaotic map and a number of iterations for the chaotic map, generating the succession of pseudo-random numbers executing iteratively the following
a) generating a pseudo-random number as a function of a final state reached by the chaotic map iterated for the current number of iterations starting from the current seed, and
b) generating a new seed for the chaotic map or a new number of iterations as a function of the final state

39. An architecture according to claim 38, wherein said processor chooses a first function defined on a phase space of the chaotic map and having values in it, and a second nonlinear function defined on the phase space of the chaotic map and with values in a set of natural numbers; and wherein generating the new seed or the new number comprises applying respectively the first and second functions on the final state.

40. An architecture according to claim 38, wherein choosing at least one chaotic map by said processor comprises choosing a plurality of chaotic maps and as many seeds and numbers of iterations; and wherein said processor further performs the following:
choosing a third function;
generating an intermediate succession of pseudo-random numbers for each chaotic map; and
generating each pseudo-random number of the intermediate succession by combining with the third function the pseudo-random numbers that are currently generated by each of the chaotic maps.

41. An architecture according to claim 38, wherein the first and second functions are chosen by said processor for each chaotic map.

42. An architecture according to claim 38, wherein the pseudo-random numbers generated by the chaotic map are obtained by multiplying by a pre-established power of ten a sum of an absolute value of the components of the state reached by the chaotic map after the number of iterations, and keeping only the integer part of the product

43. An architecture according to claim 38, wherein in a phase space of the chaotic map there is at least one attractor basin and the seed is chosen from inside the attractor basin.
